(19) United States
(12) Patent Application Publication
(10) Pub. No.: US 2025/0055859 A1
(43) Pub. Date: Feb. 13, 2025

(54) ACTIVE COMMAND AND CONTROL SERVER DETECTION VIA DISTRIBUTED NETWORK SCANNING

(71) Applicant: IronNet Cybersecurity, Inc., Vienna, VA (US)

(72) Inventors: Brett Fitzpatrick, Boston, MA (US); Daniel Cahill, Avon, IN (US); Stephen Monaco, Alamosa, CO (US); William Lane, Aldie, VA (US)

(21) Appl. No.: 18/797,332

(22) Filed: Aug. 7, 2024

Related U.S. Application Data
(60) Provisional application No. 63/531,286, filed on Aug. 7, 2023.

(51) Int. Cl. H04L 9/40

(52) U.S. Cl. CPC H04L 63/1416; H04L 63/0861

(57) ABSTRACT

Methods and systems for a network of computing devices are described. Embodiments of the present disclosure include a pipeline system that may be configured to identify a plurality of leads from amongst the computing devices by comparing data received from the computing devices to soft fingerprints. In some cases, the pipeline system may perform probing each of the plurality of leads using an emulator, and generating a threat indicator in response to the probing. Next, the pipeline system may enrich the plurality of leads in response to probing each of the plurality of leads and appending enrichment data to the threat indicator. The threat indicator and the enrichment data may be subsequently transferred to update a search cluster.

This application claims the benefit of U.S. Provisional Application No. 63/531,286, filed Aug. 7, 2023, for ACTIVE COMMAND AND CONTROL SERVER DETECTION VIA DISTRIBUTED NETWORK SCANNING which is incorporated in its entirety herein by reference.

### BACKGROUND OF THE INVENTION

### 1. Field of the Invention

The present invention relates generally to computing, and more specifically to active command and control server detection via distributed network scanning.

### 2. Discussion of the Related Art

Various systems and processes are known in the art for active command and control server detection via distributed network scanning.

Recently, the proliferation of internet-connected devices and the expansion of networks have led to increased risks associated with cybersecurity threats. A significant threat vector may include Command and Control (C&C or C2) servers, which may commonly be used by cyber attackers to coordinate and control malware-infected devices, known as botnets. In some cases, such servers may act as centralized hubs that issue commands to compromised systems, enabling attackers to execute a wide range of malicious activities, such as data exfiltration, distributed denial-of-service (DDoS) attacks, etc.

Existing methods for detecting C&C servers heavily rely on analyzing network traffic patterns, signatures, and behavior analysis. However, as cyber attackers become more sophisticated, the attackers increasingly employ techniques that obfuscate their activities and avoid detection. Therefore, there is a need in the art for systems and methods that can accurately and efficiently detect for malware.

### SUMMARY

The present disclosure describes systems and methods for active command and control server detection via distributed network scanning. Embodiments of the present disclosure include a combination of behavioral and signature detection methods to accurately identify Command and Control (C2) servers associated with malicious activities. In some cases, the method may include specific network addresses and port pairings as leads. An embodiment of the disclosure includes use of a soft fingerprinting method combined with active network scanning, enabling continuous and real-time threat analysis.

A method, apparatus, non-transitory computer readable medium, and system for active command and control server detection via distributed network scanning are described. One or more aspects of the method, apparatus, non-transitory computer readable medium, and system include identifying a plurality of leads from amongst the computing devices by comparing data received from the computing devices to soft fingerprints; probing each of the plurality of leads using an emulator, and generating a threat indicator in response to the probing; enriching the plurality of leads in response to probing each of the plurality of leads and appending enrichment data to the threat indicator; and transmitting the threat indicator and the enrichment data to update a search cluster.

An apparatus, system, and method for active command and control server detection via distributed network scanning are described. One or more aspects of the apparatus, system, and method include a leads pipeline identifying a plurality of leads from amongst the computing devices by comparing data received from the computing devices to soft fingerprints; a scanner pipeline probing each of the plurality of leads using an emulator, wherein the emulator emulates an agent for the type of command and control server for each lead, and generating a threat indicator in response to the probing; an enrichment pipeline enriching the plurality of leads in response to probing each of the plurality of leads and appending enrichment data to the threat indicator; and a shipping pipeline transmitting the threat indicator and the enrichment data to update a search cluster.

### BRIEF DESCRIPTION OF THE DRAWINGS

FIGS. 1A-1B, 2A-2C through 3 show examples of a system in a network of computing devices according to aspects of the present disclosure.

FIG. 4 shows an example of a method for computing according to aspects of the present disclosure.

### DETAILED DESCRIPTION

The present disclosure relates to systems and methods for actively detecting Command and Control (C&C) servers through distributed network scanning. Embodiments of the present disclosure are configured to utilize a network of distributed scanning nodes to actively probe and identify potential C&C servers. In some cases, the detection system may be configured to use a combination of behavior and signature based detection for fingerprinting a server for malware.

Existing methods for detecting C&C servers may face multiple challenges, including the dynamic nature of IP addresses, encryption of malicious communications, and the increasing use of legitimate cloud services for malicious purposes which increases the difficulty of identification of C&C servers with high accuracy and low false-positive rates. Moreover, conventionally used network scanning systems may provide raw network data. However, such systems are not able to identify command and control servers through active probing. In some cases, an existing system may label a complete IP as C2 using known signatures. Thus, the existing systems are unable to locate the specific port on which the command and control server may be located leading to an inefficient detection system.

By contrast, embodiments of the present disclosure are configured to use a combination of behavior and/or signature detections to fingerprint a C2 server. In some cases, a C2 agent may be imitated in a scan which enables identification of an IP and port as a command and control server. An embodiment of the present disclosure may be configured to define a lead as a network address and a port combination.

Embodiments of the present disclosure include scanning a network of computing devices for active command and control server detection. In some cases, the network may include a first plurality of sections and a second plurality of core micro services. For example, the network may include four sections and five core micro services. According to an embodiment, the network of computing devices may include a leads pipeline, a scanner pipeline, an enrichments pipeline, and a shipping pipeline.

In some cases, the leads pipeline may be configured to execute leads (e.g., a network address and port combination) and queue the leads for scanning in the scanner pipeline. Additionally, the enrichments pipeline may use logs (i.e., generated after running a scanner module in scanning pipeline) from the queue and may append enrichment data to threat indicators acquired during scanning. In some cases, the shipping pipeline may transmit logs to ElasticSearch.

Embodiments of the present disclosure include a combination of behavior and/or signature detections to fingerprint a command and control (C2) server for malware. In some cases, the pipeline system described with reference to the present disclosure may imitate a C2 agent in the scan. Accordingly, the pipeline system may confirm whether an IP port and port combination may be used by a C2 server. In some cases, the pipeline system may be used to imitate the connection of an infected host with the malicious C2 server to obtain a valid response.

According to an embodiment of the present disclosure, a lead generation query (LGQ) may be configured to search data sources and gather new targets to scan. In some cases, the new targets may be gathered based on soft fingerprints (i.e., features in network data) in a third-party source. An embodiment of the present disclosure may be configured to use a combination of soft fingerprints with active network probing. In some cases, use of the said combination may be used to label and gather threat intelligence as a continuous process.

An embodiment of the present disclosure may include a user-agent string. In some cases, when a 32-bit or a 64-bit beacon is successfully served, the system may extract the beacon configuration. Additionally, in some cases, the system may extract behavior indicators from the beacon configuration which may provide for enhanced alignment of analytics and true malicious behavior.

Accordingly, by mimicking a C2 agent in the scans, embodiments of the present disclosure are able to accurately and efficiently verify whether an IP and port combination is associated with a C2 server. Moreover, by serving different payload versions, embodiments of the present disclosure can successfully extract C2 agent configuration data. Additionally, by generating threat intelligence based on labeled data, embodiments are able to enhance security operations, and incident response teams to detect C2 servers, adversary infrastructure, understand and take action against attackers.

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The present disclosure describes systems and methods for active command and control server detection. In some cases, the command and detection may be performed via distributed network scanning.

In some cases, active network scanning systems such as BinaryDefense, Shodan, and Censys may provide raw network data, but may not be able to identify command and control servers through active probing.

Embodiments of the present disclosure include a combination of behavior and/or signature detections to fingerprint leads from amongst the computing devices. In some aspects, embodiments of the present description may implement computing agents (their scans), and may definitively confirm whether an IP+port combination is a computing device threat. Furthermore, embodiments of the present description may define leads as network address and port combinations (e.g., as opposed to labeling leads as entire network addresses, regardless of port).

For instance, leads may identify computing device threats on the network to include but not limited to: Command and Control (C2) servers, malware panels, access control servers, botnet panels, denial of service (DoS) and distributed denial of service (DDoS) panels and services, and malware as a service registration and control panels and points. This lead generation and identification is the identification of network connected computing devices that can be identified using network characteristics inherent in the computing device threat.

In some cases, open-source tools may provide a framework for advanced persistent threat (APT) groups to gain access to systems, establish C2, and launch ransomware attacks. In some cases, a threat hunter may develop a process that fingerprints a server to determine whether the server may be a C2 server.

In some cases, IronNet Counterstrike may proactively and automatically update a cybersecurity stack with IP addresses for a weaponized C2 server. For example, the IronNet Counterstrike may be an automated threat intelligence feed that combats C2 behavior by updating to a current cyber security attack to proactively block known and new unreported C2 infrastructure, by performing a simplified procurement, and by performing a rapid deployment via one-time access key to a structured and documented API.

IronRadar may enable cybersecurity teams to proactively block known and new C2 servers that may be used by advanced persistent threat (APT) groups for launching attacks. In some cases, IronRadar may provide security operations, incident response, and cyber threat intelligence teams to detect C2 servers, adversary infrastructure, understand and take action against attackers.

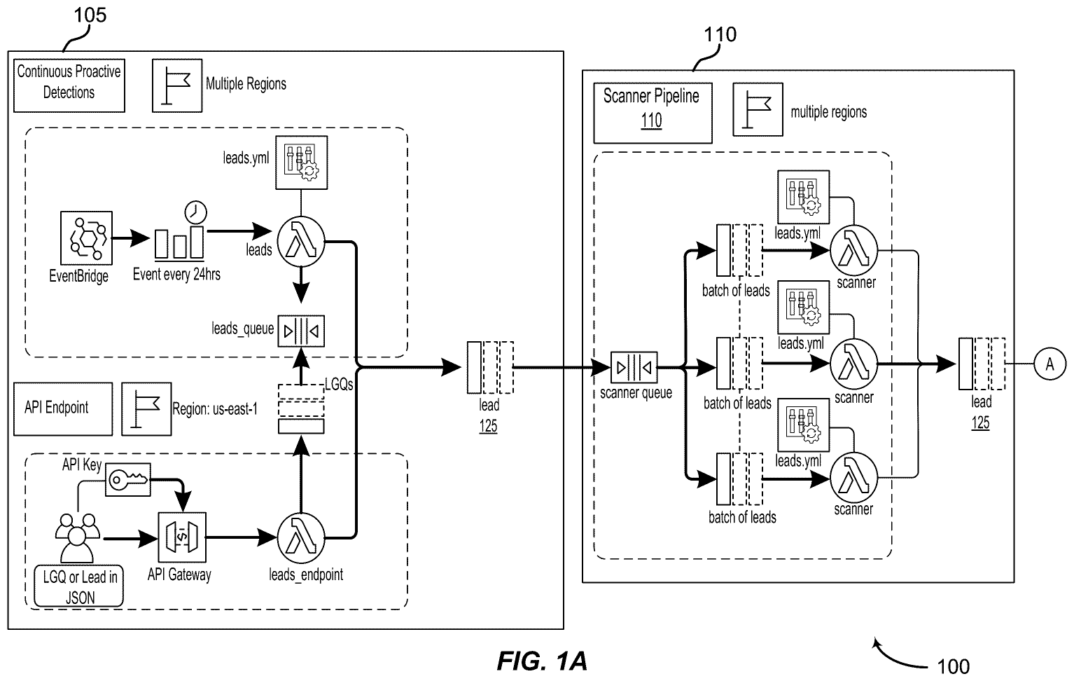

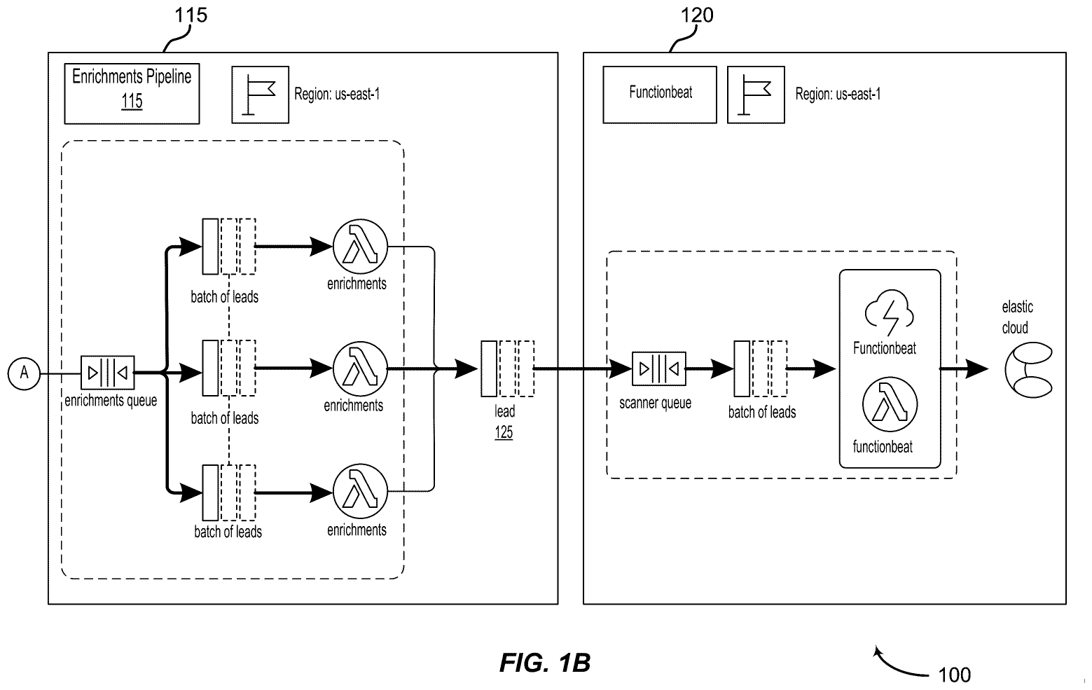

FIGS. 1A-1B show an example of a system 100 in a network of computing devices according to aspects of the present disclosure. FIG. 1A shows an example of a leads pipeline 105 and a scanner pipeline 110 according to aspects of the present disclosure. FIG. 1B shows an example of an enrichment pipeline 115 and a shipping pipeline 120 according to aspects of the present disclosure.

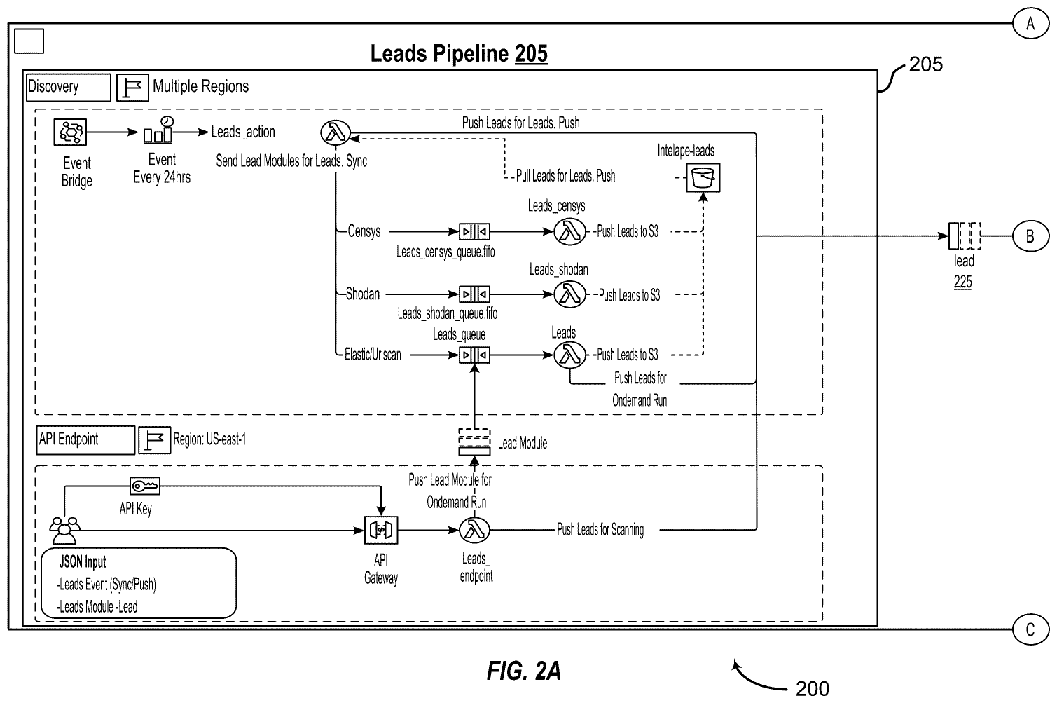

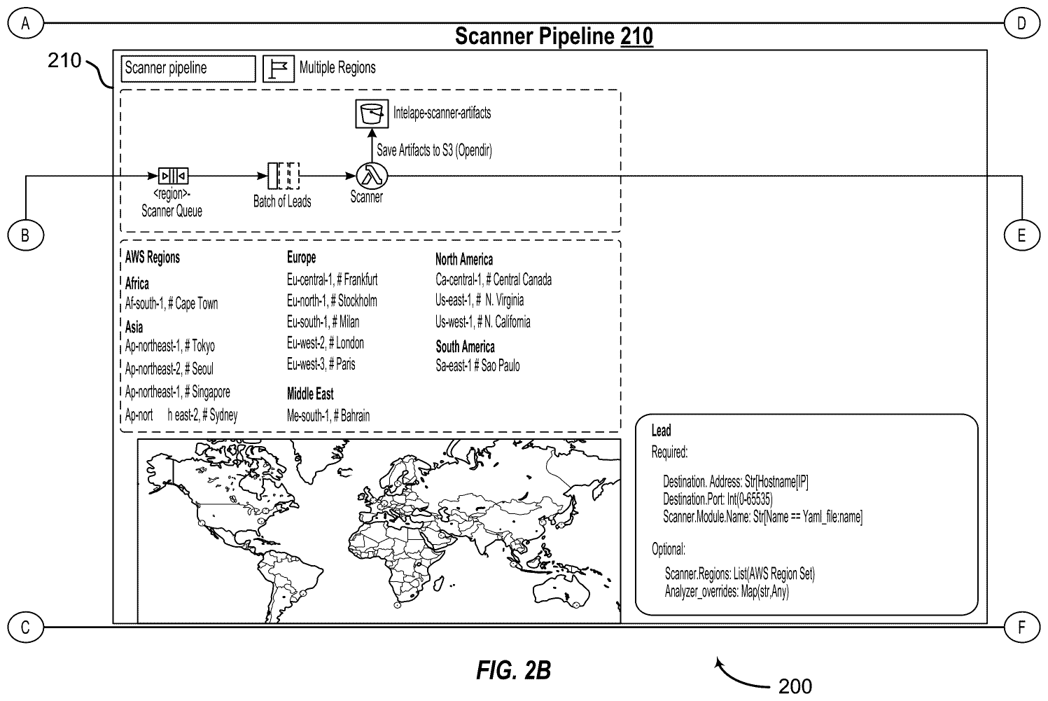

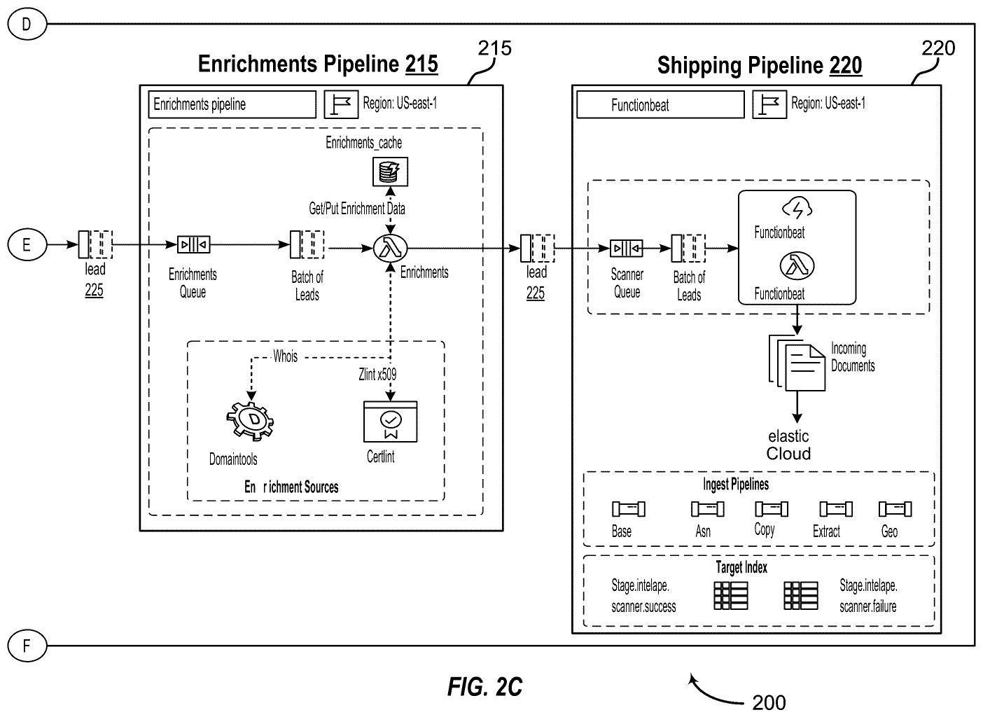

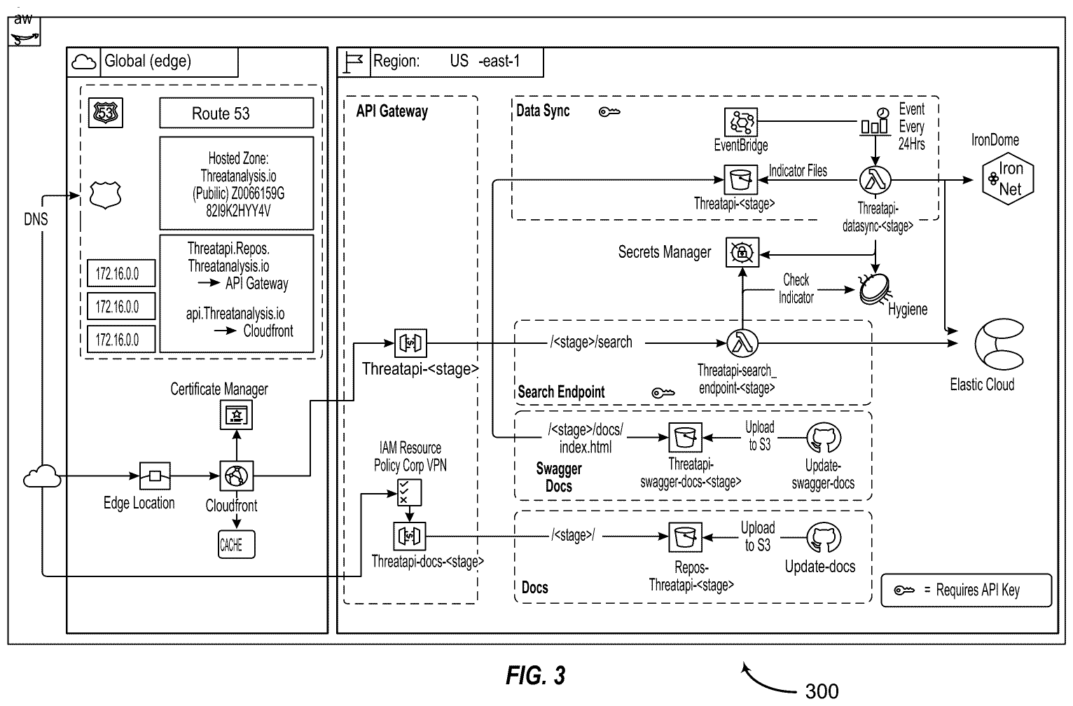

System 100 may be an example of, or include aspects of, the corresponding elements described with reference to FIGS. 2A-2C and 3. In one aspect, system 100 includes leads pipeline 105, scanner pipeline 110, enrichment pipeline 115, shipping pipeline 120, and plurality of leads 125 (e.g., which each may be examples of, or include aspects of, the corresponding elements described with reference to FIG. 2A-2C).

The leads pipeline 105 may be composed of 2 core micro services (e.g., Leads and Leads Endpoint). The leads endpoint service is an API endpoint for allowing users and systems 100 to queue “lead(s)” for scanning. The term “lead” in this example may be described as a network address and port combination. If a port is not given in the API request, default ports may be scanned (e.g., as configured or defined in the scanner module). Any correctly formatted lead that is passed to the leads endpoint service may be sent to the scanning queue to be scanned. A lead may indicate what scanning module to use in the scanner pipeline 110. If a lead generation query (LGQ) is passed into the leads endpoint, it is forwarded to the leads service for processing. The leads service executes LGQs, gathering leads (plurality of leads 125) and queueing them to the scanner pipeline 110 for analysis. LGQs execute searches across data sources to gather targets to scan. Continuous detection is achieved by continuously scanning confirmed threats daily via LGQs. New targets are gathered by using soft fingerprints in third-party data sources. Soft fingerprints are defined as features in network data.

The scanner pipeline 110 may be a single microservice that consumes scan lead(s) from an SQS queue and orchestrates running a scanner module on a lead.

The enrichment pipeline 115 may be a single microservice that consumes logs from an SQS queue and appends enrichment data to threat indicators acquired during scanning.

The shipping pipeline 120 may consume logs from an SQS queue and ships them to Elasticsearch.

Accordingly, systems and methods (e.g., for active command and control server detection via distributed network scanning) in a network of computing devices are described. One or more aspects of the systems 100 and methods may include a leads pipeline 105 identifying a plurality of leads 125 from amongst the computing devices by comparing data received from the computing devices to soft fingerprints; a scanner pipeline 110 probing each of the plurality of leads 125 using an emulator, wherein the emulator emulates an agent for the type of command and control server for each lead, and generating a threat indicator in response to the probing; an enrichment pipeline 115 enriching the plurality of leads 125 in response to probing each of the plurality of leads 125 and appending enrichment data to the threat indicator; and a shipping pipeline 120 transmitting the threat indicator and the enrichment data to update a search cluster.

In some aspects, the leads comprise address and port combinations for possible command and control servers for malware, wherein each of the possible command and control servers comprises a type of command and control server.

In some aspects, the leads pipeline 105 identifies the plurality of leads 125 based on a configuration of where to gather leads, and what leads to gather defined by a lead generation query. In some aspects, the leads pipeline 105 identifies the plurality of leads 125 using soft fingerprints.

In some aspects, the scanner pipeline 110 probing each of the leads comprises probing each of the leads with an HTTP or HTTPS request.

In some aspects, the enrichment pipeline 115 enriching comprises enriching based on analyzing an HTTP or HTTPS response. In some aspects, the enrichment pipeline 115 enriching comprises enriching based analyzing a hash of an HTTP or HTTPS response. In some aspects, the enrichment pipeline 115 enriching comprises enriching based on analyzing whether a string is contained within an HTTP or HTTPS response. In some aspects, the enrichment pipeline 115 enriching comprises enriching based on analyzing whether a regular expression is matched within an HTTP or HTTPS response. In some aspects, the enrichment pipeline 115 enriching comprises enriching based on analyzing a TCP Banner. In some aspects, the enrichment pipeline 115 enriching comprises enriching based analyzing a hash of a TCP Banner. In some aspects, the enrichment pipeline 115 enriching comprises enriching based on analyzing whether a string is contained within a TCP Banner. In some aspects, the enrichment pipeline 115 enriching comprises enriching based on analyzing whether a regular expression is matched within a TCP Banner.

Some examples of the systems 100 and methods further include a plurality of the computing devices that employ the search cluster having been updated to block access from a subset of the plurality of leads 125 based on the threat indicator and the enrichment data associated with the subset of the plurality of leads 125.

In some aspects, the plurality of computing devices employ the search cluster having been updated by: pulling intelligence indicators from the search cluster for the subset of the plurality of leads 125 based on the threat indicator and the enrichment data associated with the subset of the plurality of leads 125; and writing the intelligence indicators to files stored on a storage appliance, wherein these files are used to block access from the subset of the plurality of leads 125.

In some aspects, the scanner pipeline 110 probing comprises probing each of the plurality of leads 125 from at least two distinct regions representing at least two countries.

In some aspects, the scanner pipeline 110 probing comprises probing each of the plurality of leads 125 using at least two types of user agents. In some aspects, the scanner pipeline 110 probing comprises probing each of the plurality of leads 125 to retrieve a respective configuration file; and the enrichment pipeline 115 enriching comprises enriching each of the plurality of leads 125 by tracking changes to the configuration file over time.

According to an embodiment of the present disclosure, the leads pipeline (such as leads pipeline 105 in FIGS. 1A-1B) may serve as a starting place. In some cases, the leads pipeline includes two core micro services, i.e., the leads service and the leads endpoint service. For example, the leads endpoint service may be an API endpoint that provides for users and systems to queue the plurality of leads 125 for scanning.

In some cases, lead may refer to a network address and port combination. In case a port is not given in an API request, a default port may be scanned as described with reference to FIGS. 1A-1B. Additionally, a correctly formatted lead that may have been passed to the leads endpoint service may be sent to the scanning queue for scanning. In some cases, a lead may indicate the scanning module for use in a scanner pipeline (such as scanner pipeline 110 in FIGS. 1A-1B).

In case a lead generation query (LGQ) is passed to the leads endpoint service, the LGQ may be passed to the leads service for processing. In some cases, the leads service may execute LGQs, gather plurality of leads 125, and queue the gathered plurality of leads 125 to the scanner pipeline 110 for analysis. For example, LGQs may execute searches across data sources to gather targets to scan. In some cases, continuous detection may be achieved by continuously scanning confirmed threats, e.g., daily via LGQs. In some cases, a new target may be gathered using soft fingerprints in third-party data sources.

As described herein, a soft fingerprint may refer to features in network data. For example, a soft fingerprint may refer to a search for a single, or composite set of network observables from a data source like Shodan, Censys, or Urlscan. In some examples, Shodan and Censys may provide wide internet scanning data that may be used for categorizing the internet.

Referring to FIGS. 1A-1B, the scanner pipeline (such as scanner pipeline 110) may be a single microservice that may consume scan lead(s) from an SQS queue and may orchestrate running a scanner module (in the scanner pipeline in FIGS. 1A-1B) on a lead.

According to an embodiment, an enrichments pipeline (such as enrichments pipeline 115 in FIGS. 1A-1B) may be a single microservice that may consume logs from an SQS queue. Additionally, the enrichments pipeline 115 may append enrichment data to threat indicators acquired during scanning. In some cases, the enrichments pipeline 115 may consume logs from an SQS queue and may ship the consumed logs to Elastic search.

The present disclosure describes systems and methods for active command and control server detection. In some cases, the command and detection may be performed via distributed network scanning.

In some cases, active network scanning systems such as BinaryDefense, Shodan, and Censys may provide raw network data, but may not be able to identify command and control servers through active probing.

Embodiments of the present disclosure include a combination of behavior and/or signature detections to fingerprint a command and control (C2) server for malware. In some cases, the pipeline system described with reference to the present disclosure may imitate a C2 agent in the scan. Accordingly, the pipeline system may confirm whether an IP port and port combination may be used by a C2 server. An embodiment of the disclosure provides leads as network address and port combinations. In some cases, leads may be labeled as an entire network address, regardless of port.

FIGS. 2A-2C show an example of a system 200 in a network of computing devices according to aspects of the present disclosure. FIG. 2A shows an example of a leads pipeline 205 according to aspects of the present disclosure. FIG. 2B shows an example of a scanner pipeline 210 according to aspects of the present disclosure. FIG. 2C shows an example of enrichments pipeline 215 and a shipping pipeline 220 according to aspects of the present disclosure.

System 200 may be an example of, or include aspects of, the corresponding elements described with reference to FIGS. 1A-1B and 3. In one aspect, system 200 includes leads pipeline 205, scanner pipeline 210, enrichment pipeline 215, shipping pipeline 220, and plurality of leads 225 (e.g., which each may be examples of, or include aspects of, the corresponding elements described with reference to FIGS. 1A-1B).

The leads pipeline 205 may be composed of 2 core micro services (e.g., Leads and Leads Endpoint). The leads endpoint service is an API endpoint for allowing users and systems 200 to queue “lead(s)” for scanning. The term “lead” in this example may be described as a network address and port combination. If a port is not given in the API request, default ports may be scanned (e.g., as configured or defined in the scanner module). Any correctly formatted lead that is passed to the leads endpoint service may be sent to the scanning queue to be scanned. A lead may indicate what scanning module to use in the scanner pipeline 210. If a lead generation query (LGQ) is passed into the leads endpoint, it is forwarded to the leads service for processing. The leads service executes LGQs, gathering leads and queueing them to the scanner pipeline 210 for analysis. LGQs execute searches across data sources to gather targets to scan. Continuous detection is achieved by continuously scanning confirmed threats daily via LGQs. New targets are gathered by using soft fingerprints in third-party data sources. Soft fingerprints are defined as features in network data.

The scanner pipeline 210 may be a single microservice that consumes scan lead(s) from an SQS queue and orchestrates running a scanner module on a lead.

The enrichment pipeline 215 may be a single microservice that consumes logs from an SQS queue and appends enrichment data to threat indicators acquired during scanning.

The shipping service may consume logs from an SQS queue and ship them to Elasticsearch.

Accordingly, systems and methods (e.g., for active command and control server detection via distributed network scanning) in a network of computing devices are described. One or more aspects of the systems 200 and methods may include a leads pipeline 205 identifying a plurality of leads 225 from amongst the computing devices by comparing data received from the computing devices to soft fingerprints; a scanner pipeline 210 probing each of the plurality of leads 225 using an emulator, wherein the emulator emulates an agent for the type of command and control server for each lead, and generating a threat indicator in response to the probing; an enrichment pipeline 215 enriching the plurality of leads 225 in response to probing each of the plurality of leads 225 and appending enrichment data to the threat indicator; and a shipping pipeline 220 transmitting the threat indicator and the enrichment data to update a search cluster.

In some aspects, the leads comprise address and port combinations for possible command and control servers for malware, wherein each of the possible command and control servers comprises a type of command and control server.

In some aspects, the leads pipeline 205 identifies the plurality of leads 225 based on a configuration of where to gather leads, and what leads to gather defined by a lead generation query. In some aspects, the leads pipeline 205 identifies the plurality of leads 225 using soft fingerprints.

In some aspects, the scanner pipeline 210 probing each of the leads comprises probing each of the leads with an HTTP or HTTPS request.

In some aspects, the enrichment pipeline 215 enriching comprises enriching based on analyzing an HTTP or HTTPS response. In some aspects, the enrichment pipeline 215 enriching comprises enriching based analyzing a hash of an HTTP or HTTPS response. In some aspects, the enrichment pipeline 215 enriching comprises enriching based on analyzing whether a string is contained within an HTTP or HTTPS response. In some aspects, the enrichment pipeline 215 enriching comprises enriching based on analyzing whether a regular expression is matched within an HTTP or HTTPS response. In some aspects, the enrichment pipeline 215 enriching comprises enriching based on analyzing an TCP Banner. In some aspects, the enrichment pipeline 215 enriching comprises enriching based analyzing a hash of a TCP Banner. In some aspects, the enrichment pipeline 215 enriching comprises enriching based on analyzing whether a string is contained within a TCP Banner. In some aspects, the enrichment pipeline 215 enriching comprises enriching based on analyzing whether a regular expression is matched within a TCP Banner.

Some examples of the systems 200 and methods further include a plurality of the computing devices that employ the search cluster having been updated to block access from a subset of the plurality of leads 225 based on the threat indicator and the enrichment data associated with the subset of the plurality of leads 225.

In some aspects, the plurality of computing devices employ the search cluster having been updated by: pulling intelligence indicators from the search cluster for the subset of the plurality of leads 225 based on the threat indicator and the enrichment data associated with the subset of the plurality of leads 225; and writing the intelligence indicators to files stored on a storage appliance, wherein these files are used to block access from the subset of the plurality of leads 225.

In some aspects, the scanner pipeline 210 probing comprises probing each of the plurality of leads 225 from at least two distinct regions representing at least two countries.

In some aspects, the scanner pipeline 210 probing comprises probing each of the plurality of leads 225 using at least two types of user agents. In some aspects, the scanner pipeline 210 probing comprises probing each of the plurality of leads 225 to retrieve a respective configuration file; and the enrichment pipeline 215 enriching comprises enriching each of the plurality of leads 225 by tracking changes to the configuration file over time.

According to an embodiment of the present disclosure, the leads pipeline (such as leads pipeline 205 in FIG. 2A-C) may serve as a starting place. In some cases, the leads pipeline 205 includes two core micro services, i.e., the leads service and the leads endpoint service. For example, the leads endpoint service may be an API endpoint that provides for users and systems to queue the plurality of leads 225 for scanning.

In some cases, a lead may refer to a network address and port combination. In case a port is not given in an API request, a default port may be scanned as described with reference to FIGS. 1A-1B and 2A. Additionally, a correctly formatted lead that may have been passed to the leads endpoint service may be sent to the scanning queue for scanning. In some cases, a lead may indicate the scanning module for use in a scanner pipeline (such as scanner pipeline 210 in FIG. 2B).

In case a lead generation query (LGQ) is passed to the leads endpoint service, the LGQ may be passed to the leads service for processing. In some cases, the leads service may execute LGQs, gather a plurality of leads 225, and queue the gathered plurality of leads 225 to the scanner pipeline 210 for analysis. For example, LGQs may execute searches across data sources to gather targets to scan. In some cases, continuous detection may be achieved by continuously scanning confirmed threats, e.g., daily via LGQs. In some cases, a new target may be gathered using soft fingerprints in third-party data sources.

As described herein, a soft fingerprint may refer to features in network data. For example, a soft fingerprint may refer to a search for a single, or composite set of network observables from a data source like Shodan, Censys, or Urlscan. In some examples, Shodan and Censys may provide wide internet scanning data that may be used for categorizing the internet.

An embodiment of the present disclosure may be configured to scan a small set of targets that may match a specific set of criteria. In some examples, a small set of targets, i.e., hostname/IP and port combinations may be scanned instead of each of the public IPv4 hosts readable via the Internet and the service ports resulting in high efficiency in terms of resources and time. For example, datasets from sources such as Shodan and Censys may be used to gather the data.

Embodiments of the present disclosure may be configured to request the data source to return each of the target, hostname, and port combinations. In some cases, the returned targets, hostnames, and port combinations may exhibit the service banner or resemble the banner. For example, the data source may be requested using a question such as, show me all of the HTTP services that have the HTTP header “X-AspNet-Version: 4.0.30319”.

Referring to FIGS. 1A-1B and 2B, the scanner pipeline (such as scanner pipeline 110 and scanner pipeline 210) may be a single microservice that may consume scan lead(s) from an SQS queue and may orchestrate running a scanner module (in the scanner pipeline in FIGS. 1A-1B and 2B) on a lead.

According to an embodiment, an enrichments pipeline (such as enrichments pipeline 115 in FIGS. 1A-1B and 215 in FIG. 2C) may be a single microservice that may consume logs from an SQS queue. Additionally, the enrichments pipeline 215 may append enrichment data to threat indicators acquired during scanning. In some cases, the enrichments pipeline 215 may consume logs from an SQS queue and may ship the consumed logs to Elastic search.

According to an exemplary embodiment, the search clusters may be employed to block access from a subset of the plurality of leads 225. In some cases, the access may be blocked by pulling intelligence indicators from a search cluster and by writing the intelligence indicators to files that may be stored on a storage appliance. For example, the intelligence indicators may be written on appliances such as AWS S3. In some cases, the files may be used to block access, i.e., instead of accessing the data directly from the search cluster.

According to an exemplary embodiment of the present disclosure, IntelAPE may refer to a framework and stack for conducting proactive threat intelligence (PTI) generation. In some cases, IntelARM may refer to a framework and stack for conducting Proactive/Reactive threat intelligence (PTI/RTI) analysis.

According to an exemplary embodiment, the IntelAPE stack may refer to a serverless network scanning architecture for PTI generation. In some cases, the IntelAPE may include four core pipelines that may work asynchronously.

Referring to FIGS. 2A-2C, the leads pipeline 205 may start the IntelAPE pipeline by producing leads (e.g., a plurality of leads 225) and sending the produced leads (e.g., a plurality of leads 225) to regional scanner SQS queues.

In some cases, a lead may define a target to scan and the name of the scanner module (such as scanner module in scanning pipeline 210) that may be used for the scanning operation. In some cases, a target may include a destination.address and a destination.port. In some cases, the destination.address may be a raw hostname or an IP address.

FIG. 2B shows a scanner pipeline 210 that may consume the leads (e.g., a plurality of leads 225) from the scanner SQS queue and may orchestrate running a scanner module. In some cases, the scanner pipeline 210 may output logs to the enrichment queue (for enrichments pipeline 215 in FIG. 2C). According to an embodiment, the scanner module may include an array of analyzers to run in order. For example, the analyzers may be used to perform N number of requests to identify a service. In cases when the threat may be identified, observables may be extracted from response data, and indicators may be generated based on the target service.

As described herein, an observable may represent individual data elements, artifacts, or entities that may be relevant to cybersecurity investigations and threat intelligence analysis. In some cases, the data elements may be typically extracted from various sources, such as network traffic, file artifacts, and a digital evidence.

As described herein, an indicator may refer to a subset of observables and may represent unique elements, artifacts, or entities, and specific patterns or behaviors derived from cybersecurity threat intelligence. In some cases, an indicator may be used to indicate the presence of a malicious activity or a potential security incident. For example, an indicator may include a network indicator such as IP addresses, domain names, and URLs associated with malicious activity, file hashes of malicious files, patterns in log files or intrusion detection system alters. Additionally, an indicator may include behavioral signatures that may be indicative of specific malware or attack techniques.

Referring to FIG. 2C, the enrichment service (e.g., in the enrichments pipeline 215) may consume logs from the enrichments SQS queue, may append enrichment data and may output logs to the shipping SQS queue.

According to an embodiment, the shipping service (e.g., in the shipping pipeline 220 shown in FIG. 2C) may consume logs from the shipping SQS pipeline and may ship the consumed logs to a search cluster or cloud (e.g., such as Elastic Cloud). In some cases, the incoming document may be transmitted through an ingest pipeline based on the target index. For example, the ingest pipelines may enrich, copy, and extract data. In some examples, the documents may be written using the write aliases (e.g., stage.intelape.scanner.success or stage.intelape.scanner.failure).

According to an embodiment, data may be forwarded to a correct stage based on the name of the SQS queue that an incoming document may originate from. In some cases, the name of the SQS queue may include the stage.

In some examples, the data schema for IntelAPE and IntelARM may be derived from an implementation of an elastic common schema (ECS) that may incorporate each of the ECS field sets and a custom field set.

According to an embodiment, the leads pipeline 205 may start the IntelAPE pipeline based on generating a plurality of leads 225. In some cases, a lead may define the scanning information (e.g., who to scan, what to scan for, and where to scan from). A lead may be gathered on a routine basis using lead modules that contain configuration on the location for gathering the lead (e.g., where to gather the plurality of leads 225 from, i.e., external or internal data source). As such, the gathering of the lead may result in gathering as defined by the lead generation query (LGQ). Additionally, the scanner module (such as the scanner module in scanning pipeline 210 in FIG. 2B) may execute on the plurality of leads 225.

An embodiment of the present disclosure may include three core events that may start the execution of the leads pipeline, i.e., user input may be pushed to leads endpoint, leads.sync, and leads.push. In some cases, a user may push JSON input to the leads.endpoint which may refer to a lead, a leads module (in leads pipeline 205), or a leads event (e.g., push/sync). In some cases, lead modules that may be pushed to the leads service via the API may be executed immediately. Additionally, such lead modules may be sent to the scanner regions set by the user, or default to INTELAPE_MAIN_AWS_REGIONS.

According to an embodiment, the leads sync may send lead modules to the leads SQS pipeline such that plurality of leads 225 may be gathered from data sources and stored in S3 for subsequent scanning. In some cases, the plurality of leads 225 may be prepared to be pushed by the leads-push event. In some examples, leads push may pull the plurality of leads 225 from S3 and may push the plurality of leads 225 to a defined region list. In some examples, the region list may default to INTELAPE_MAIN_AWS_REGIONS.

According to an exemplary embodiment, leads action may refer to a lambda function that may process events pushed by AWS EventBridge. In some cases, leads action may use the same container image and python entrypoint as the plurality of leads 225 (i.e., leads action and leads may differ in name for infrastructure deployment). According to an embodiment, the default leads service may handle multiple events in the leads pipeline (such as leads pipeline 205 in FIG. 2A).

For example, leads.sync and leads.push may be event types push by EventBridge. As described herein, leads.sync may pull the plurality of leads from data sources and save the plurality of leads to S3. Subsequently, leads.push may pull the plurality of leads and push the plurality of leads to scanner queues. In some cases, leads action may use the same container image and python entrypoint as plurality of leads (i.e., leads action and leads may differ in name for infrastructure deployment).

In some cases, lead modules (such as lead modules in lead pipeline 205) may include lead generation queries that may leverage data sources. In some cases, such data sources that may not rate limit, the requests may use default leads service that provides for unlimited scaling based on the number of events in the SQS queue. In some cases, data sources that use rate limiting may include dedicated leads service derivative such that rate limiting may be performed by infrastructure design. In some cases, the default leads service may handle multiple events in the leads pipeline 205.

According to an embodiment, the leads service may handle the processing of lead modules (such as lead modules in lead pipeline 205) that may be pushed to the service. In some cases, the service may pull data using the provided source and query configuration in the leads module and then may translate the return data into Intelape leads format. Subsequently, i.e., after data translation, the plurality of leads 225 may be written to S3 before being selected and pushed to scanner queries.

In some cases, a lead module that may include lead generation queries and that may leverage data sources that may not rate limit, the requests may use the default leads service. In some cases, the default leads service provides for unlimited scaling based on the number of events in the SQS queue. In some cases, data sources that may use rate limiting may include dedicated leads service derivative such that rate limiting may be performed based on infrastructure design.

Embodiments of the present disclosure may be configured to gather the plurality of leads 225 using soft fingerprints. Accordingly, by using soft fingerprints (i.e., instead of scanning each IPv4/6 address and port combination), embodiments of the present disclosure are able to use a manageable set of targets to scan and provide for a cost reduction in gathering overall intelligence.

According to an embodiment of the present disclosure, the scanner service may consume the plurality of leads from an SQS pipeline and may run a scanner module. For example, the scanner module in scanning pipeline 210 may be defined in the scanner.yml file and may include a module field, a version field, a ports field, and an analyzers field. In some examples, the module field may refer to the name of the scanner module that may be used to find scanner modules in LGQs. In some examples, the version field may include a version of the scanner module and may be used for tracking changes in the output data. In some examples, the port field may refer to the default ports to scan for a lead when a port may not be provided. In some examples, the analyzers field (at least one analyzer field may be used in the scanner module) may execute configurations on a lead.

An embodiment of the present disclosure includes an operation of the scanner pipeline. In some cases, the scanner pipeline 210 in FIG. 2B may read in plurality of leads 225, create a task for each lead and scanner module, execute each analyzer in order, and collect logs from tasks and output to the enrichments SQS queue.

As described herein, an analyzer may output one or more logs for a lead which enhances the importance of the order of the analyzers. In some examples, a single-log analyzer may be placed before a multi-log analyzer. In some cases, the scanner pipeline 210 may consume plurality of leads 225 from the scanner SQS queue.

According to an embodiment of the present disclosure, an enrichments pipeline may consume logs from an SQS queue and may append enrichment data. In a case of threat, an enrich indicator (such as an enrich indicator of an enrichments pipeline 215 shown in FIG. 2C) may loop through threat.indicators. In cases where threat.indicator.value is a domain name, the enrich indicator may attempt to enrich record with DomainTools.ParsedWhois endpoint. Additionally, the enrich indicator may check hygiene with threat.indicator.value. In case the indicator is positive, the indicator object may be moved to threat.indicator_hygiene array. In case a destination.ip exists, the enrich indicator may attempt to enrich record with Censys services data. In case the tls.server.certificate exists, the enrich indicator may send certificate to Certlint (i.e., ZLint) and may append linting results. Finally, the enrich indicator may send a record to shipping queue for indexing to Elasticsearch. In some cases, the enrich indicator may send a record to shipping queue for indexing to Elasticsearch.

In some cases, data in the enrichments cache may be stored by the host being the key. Additionally, the value may be a JSON blob of enrichments data where the source of the data may be the key and the value may refer to the data.

An embodiment of the present disclosure includes a shipping pipeline. In some cases, the shipping service (shipping service of shipping pipeline 220 shown in FIG. 2C) may consume logs from an SQS queue and may ship the logs to a search cluster or cloud (e.g., such as Elastic Cloud). In some examples, data may be written to the index alias intelape for production and dev-intelape for testing. For example, the tag test may be used in query.tags to send data to the dev alias.

A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

An exemplary embodiment includes an application that may send JSON-encoded events to an SQS queue. In some cases, Functionbeat may listen for, ingest, and decode JSON events prior to shipping the events to ElasticSearch. For example, the streaming data may be analyzed at ElasticSearch.

In some examples, the processing pipeline may include Functionbeat that may be implemented as a serverless shipper and may listen to an SQS queue for application events. Additionally, for example, the processing pipeline may include the Beats decode json fields processor that may decode JSON strings and may replace the decoded strings with valid JSON objects. In some examples, the events may be indexed into an ElasticSearch cluster.

According to an embodiment, in case of failure when sending data to ElasticSearch, the log may be shipped to a Dead Letter Queue to mitigate data loss. In some cases, the log may be resent manually (e.g., the manual resending may use an intervention).

In case of an ECS change, a new ECS artifact may be generated prior to proceeding with a Functionbeat update.

In some cases, an index template may be updated with a new component template that may be updated after generating artifacts. For example, the said updates may be applied and verified to the dev index template prior to updating the prod template. In some examples, a new component template may be added or an existing template may be updated by visiting the component template page. In some examples, a new index may be used to perform an update to an existing field or to perform a major change. For example, the said updates may be manually triggered by performing a rollover on the index. Subsequently, the updated template may be saved.

An embodiment of the present disclosure describes the edits to the configuration file prior to deployment of Functionbeat. In some cases, STAGE may be replaced with dev or prod. Next, instrumentation.environment may be replaced with development or production. Additionally, instrumentation.secret token and output.elasticsearch.spi_key may be set.

In some cases, after editing the Functionbeat configuration file, a make target (e.g., make Functionbeat-intelape) may be used to deploy the Functionbeat stack.

As described herein, a lead may refer to a scanner target with a scanner module. A scan target may include a destination.address (i.e., destination network address) with a destination.port (i.e., port of the destination). In case a port is not specified, the scanning module may specify the default service ports for interrogation.

According to an embodiment, the default leads service may handle multiple events in the leads pipeline (e.g., such as leads pipeline 105 and/or 205 as described with reference to FIGS. 1A-1B and 2A-2C).

The leads service may handle the processing of lead modules that may be pushed to the service via the leads.sync action. In some cases, the service may pull data using a provided source and query configuration in the leads module. Subsequently, the service may translate the return data into intelape leads format. Next, the plurality of leads may be written on S3 such that leads.push may select the plurality of leads and push the plurality of leads to scanner queues.

According to an embodiment, the leads service may handle the processing of lead modules (such as lead modules in lead pipeline 105 and/or 205) that may be pushed to the service via the leads.sync action. In some cases, the service may pull data using the provided source and query configuration in the leads module and then may translate the return data into intelape leads format. Subsequently, i.e., after data translation, plurality of leads may be written to S3 such that leads.push may select the plurality of leads and push the selected plurality of leads to scanner queries.

In some examples, a capability of leads.action may use the same code as the plurality of leads. In some cases, a user event may be processed based on user input which provides for a user to start loads.sync or loads.push in case of a pipeline error or for syncing/pushing a module.

According to an embodiment, a user may manually implement a lead module. In some cases, a lead service may accept a lead module and may perform actions, such as pulling the data source and pushing the data to scanner queries. For example, a manual execution of the lead module may not save the plurality of leads to S3 as the manual selection pulls leads into memory and pushes the plurality of leads to scanner queries.

In some cases, the leads_Censys may refer to a lambda function for processing Censys lead modules sent to the queue by leads action after processing a leads.sync event. For example, leads Censys may use the same container image and python entry point as the plurality of leads and may be separated in infrastructure deployment to achieve rate limiting by design.

As described herein, rate limiting may be implemented by design based on connecting a lambda function to a SQS FIFO queue that may be triggered with a batchSize of 1. Therefore, the lambda function may process one event at a time from the queue.

In some cases, leads Shodan may refer to a lambda function for processing Shodan lead modules sent to the queue by leads action after processing a leads.sync event. For example, leads Shodan may use the same container image and python entrypoint as the plurality of leads. Additionally, leads Shodan may include the same rate limiting technique as leads_Censys.

In some cases, leads_endpoint service may provide for pushing an event to the leads pipeline and scanning pipeline (e.g., such as leads pipeline 105/205 and scanning pipeline 110/210 as described with reference to FIGS. 1A-1B and 2A-2C). For example, the leads endpoint may accept 3 types of JSON events, i.e., a simple lead, a leads module, or a leads event (e.g., push/sync). In some examples, leads modules and events may be pushed to the leads service while the plurality of leads may be pushed to the defined scanner region, in the lead, queues or the default scanner region queues.

As described, a user may sent a POST request to AWS API gateway which may invoke a lambda function that may pass the event to leads_endpoint.handler handler function. In some examples, the input may be provided in the body of the post in JSON. For example, a response such as 2xx successful may indicate the event may be successfully processed and pushed to the relevant SQS queue. For example, a response such as 4xx error may indicate that an error may have occurred when processing the user input.

As described herein, three types of input may be pushed to the leads endpoint service, i.e., a simple lead, a leads module, or a leads event (e.g., push/sync).

According to an embodiment, leads events may control the syncing of the plurality of leads to S3 and pushing the plurality of leads from S2 to SQS scanner queries. In some cases, a leads sync may send leads modules to the leads SQS pipelines such that the plurality of leads may be gathered from the data sources and stored in S3 for later scanning.

According to an embodiment, leads push may pull the plurality of leads from S3 and may be pushed to the defined region list. In some cases, the plurality of leads may default to INTELAPE_MAIN_AWS_REGIONS. In some examples, a leads module may be sent to the leads endpoint to pass onto the leads service. For example, a leads module sent to the leads_endpoint may be immediately executed with the plurality of leads pushed to the default scanner regions.

Embodiments of the present disclosure may be configured to gather leads using soft fingerprints. Accordingly, by using soft fingerprints (i.e., instead of scanning each IPv4/6 address and port combination), embodiments of the present disclosure are able to use a manageable set of targets to scan and provide for a cost reduction in gathering overall intelligence.

According to an embodiment, leads service may support four data sources for gathering the plurality of leads. For example, the supported data sources may include Censys (Censys search endpoint), elastic (threat analysis Elasticsearch cluster), Shodan (Shodan search endpoint), and Urlscan (Urlscan.io search endpoint).

In some cases, Censys lead generation queries (LGQs) may be configured based on a source set to Censys and a valid search query. For example, the source Censys may enable the lead service to use the data source Censys and the query may be for the leads service to use on the target data source.

As described herein, an analyzer may refer to an independent network scanner that may operate on the plurality of leads. Scanning modules (such as scanning modules in scanner pipeline 110/210 in FIGS. 1A-1B and 2A-2C) may encompass a single or a combination of analyzers to identify a threat. In some cases, analyzers may be implemented in the order of being defined in the scanning module.

According to an embodiment, an analyzer may be asynchronous coroutines that may be designed to be independent and configurable. In some cases, an analyzer may be used for a general network scanning purpose or may be tailored for a specific threat or identification of a service.

According to an embodiment, an analyzer may be a python dataclass. In case an analyzer is a threat analyzer, the threat attribute of the analyzer object may be set to True.

In some cases, an analyzer may use two parameters, i.e., lead and analyzer_config. For example, the lead may refer to the lead log including information from the lead and data of previously run analyzers. For example, the analyzer_config may be sent from the scanner module (such as scanner module in scanner pipelines 110/210). In some examples, an analyzer may output a single or a list of logs.

An embodiment of the present disclosure describes an operation of the analyzer. In some cases, the analyzer config may be read and the analyzer may be configured. Next, the network scan operation may be performed. In some cases, a result of the network scan operation may be written to the lead object and the configured options may be saved as meta. In case the scan is unsuccessful, an error that may have occurred may be written followed by retuning the lead object.

FIG. 3 shows an example of a system 300 in a network of computing devices according to aspects of the present disclosure. FIG. 3 may illustrate an exemplary set of services that may be used to implement embodiments of the present disclosure. In some aspects, system 300 may be an example of, or includes aspects of, corresponding system elements described with reference to FIGS. 1A-1B and 2A-2C. For instance, in some aspects, system 300 may include or supplement leads pipeline, scanner pipeline, enrichment pipeline, shipping pipeline, plurality of leads, etc.

A threat analyzer may refer to an analyzer that may identify a threat. In case a threat analyzer is used in a scanner module, the scanner module may define a threat section describing the threat being identified.

In some cases, MITRE ATT&CK software fields may be incorporated following ECS's field names. In some cases, the field names may be followed and in case of a threat defined by MITRE, the details of the ECS's field names may match as defined by MITRE. For example, the software fields may include threat.software.name, threat.software.id, threat.software.reference, and threat.software.type.

In some cases, a general analyzer may refer to an analyzer that may not be tied to a specific threat and may perform general network scanning operations.

In some cases, the HTTP response analyzer may perform an HTTP request as defined in the analyzer configuration. Additionally, the HTTP response analyzer may analyze the HTTP response for content matches. For example, the HTTP response analyzer may first attempt an http request. In case of failure of the said request, https may be attempted without validating the certificate.

In some cases, the http.response analyzer may include two configurable blocks, i.e., request and response. As described herein, the request block may enable an analyzer to build the http request. As described herein, the response block may enable the analyzer to interpret the http response.

According to an embodiment, a tag may be added to an output data. For example, a tag may added using the field tags under http.response. As described herein, a tag may refer to an array of strings that may be written to http.response.tags which may be used to label or group data from similar scanning modules.

An embodiment of the present disclosure includes four types of supportable content matches. In some cases, a RESPONSE type may refer to the matching type with the maximum granularity and strictness. For example, the RESPONSE type may ensure a match of each response configuration. In some cases, a HASH type may refer to a match that may compare a hash with the sha256(http.response.body). In some cases, a CONTAINS type may take a string and evaluate in case the string may be present in the http.response.body. In some cases, a REGEX type may take a regular expression and may find a match in the http.response.body.

An embodiment of the present disclosure includes a TCP banner analyzer. In some cases, the operation of the TCP banner analyzer is similar to the HTTP response analyzer. According to an embodiment, the TCP banner analyzer may support three types of content matches. In some cases, the supported content matches include HASH, CONTAINS, and REGEX. In some cases, the HASH type may refer to a match that compares a hash with the sha256(tcp.banner). In some cases, the CONTAINS type may evaluate presence of a received string in the tcp.banner. In some cases, the REGEX type may identify a match of a received expression in the tcp.banner.

In some examples, the cobalt strike http-beacon-stager analyzer may perform HTTP requests to ensure (e.g., trick) a cobalt strike teamserver serves a BEACON. For example, an analysis of a decompiled code of Cobalt Strike shows that Cobalt Strike uses a checksum of the URL. In some examples, an algorithm (i.e., checksum8) may be used to serve 32-bit and 64-bit versions of the payload. In some examples, a bruteforce value may used for 32-bit and 64-bit payload, respectively. In some cases, a payload may be received when querying a Cobalt Strike server that includes an enabled Metasploit compatibility with the HTTP paths.

According to an embodiment of the present disclosure, a user-agent string may be used. In some cases, a user-agent string may be used since Cobalt Strike may filter abnormal user-agents. In case a 32-bit or a 64-bit beacon is successfully served, the system may extract the beacon configuration. In some examples, the beacon configuration may comprise network indicators of compromise (e.g., domains, IPs, HTTP paths, user-agents, etc.) that may enable an immediate action. Additionally, in some cases, the system may extract behavior indicators from the beacon configuration (e.g., jitter) which may be used by the analytics for training. For example, indicators such as domain and IP are capable of rotation. In some examples, the system may capture the behavioral features (such as rotation, etc.) which provides for enhanced alignment of the analytics and true malicious behavior.

An embodiment of the present disclosure may be configured to identify cobalt strike team servers. In some cases, the Cobalt Strike Team Servers may be identified based on a successful serving of a Cobalt Strike x86 (32-bit) and/or x64 (64-bit) beacon. An embodiment may be configured to identify a server for distributing DNS/HTTP/HTTPS beacons.

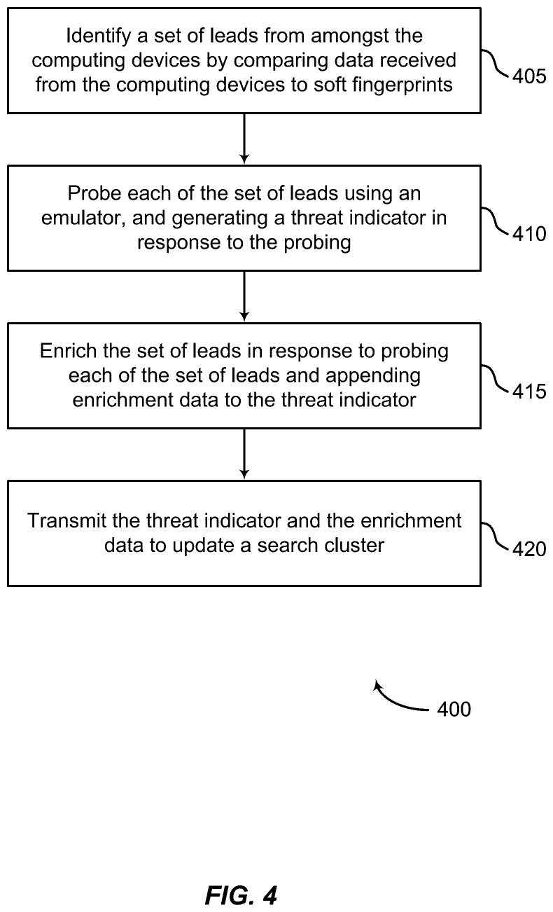

FIG. 4 shows an example of a method 400 for computing according to aspects of the present disclosure. In some examples, these operations are performed by a system including a processor executing a set of codes to control functional elements of an apparatus. Additionally, or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system identifies a set of leads from amongst the computing devices by comparing data received from the computing devices to soft fingerprints. In some cases, the operations of this step refer to, or may be performed by, a system as described with reference to FIGS. 1A-1B, 2A-2C and 3. In some cases, the operations of this step refer to, or may be performed by, a leads pipeline as described with reference to FIGS. 1A-1B, 2A-2C and 3.

At operation 410, the system probes each of the set of leads using an emulator, and generating a threat indicator in response to the probing. In some cases, the operations of this step refer to, or may be performed by, a system as described with reference to FIGS. 1A-1B, 2A-2C and 3. In some cases, the operations of this step refer to, or may be performed by, a scanner pipeline as described with reference to FIGS. 1A-1B, 2A-2C and 3.

At operation 415, the system enriches the set of leads in response to probing each of the set of leads and appending enrichment data to the threat indicator. In some cases, the operations of this step refer to, or may be performed by, a system as described with reference to FIGS. 1A-1B, 2A-2C and 3. In some cases, the operations of this step refer to, or may be performed by, an enrichment pipeline as described with reference to FIGS. 1A-1B, 2A-2C and 3.

At operation 420, the system transmits the threat indicator and the enrichment data to update a search cluster. In some cases, the operations of this step refer to, or may be performed by, a system as described with reference to FIGS. 1A-1B, 2A-2C and 3. In some cases, the operations of this step refer to, or may be performed by, a shipping pipeline as described with reference to FIGS. 1A-1B, 2A-2C and 3.

According to an embodiment of the present disclosure, datapedia may be derived from implementation of an elastic common schema (ECS) field and a custom field set. As described herein, ECS may refer to a schema or the repo/tooling used to maintain the schema.

As described herein, artifacts may refer to files or programs that may be generated based on ECS. A field set may refer to a group of related fields in ECS.

As described herein, a schema may refer to a group of related fields in ECS. In some examples, a schema may refer to a field set. Additionally, a schema definition may refer to a markup to define a schema in ECS. As used herein, attributes may refer to the properties of a field or field set that may be used to define the field or field set in a schema definition.

An embodiment of the present disclosure may include an ECS. In some cases, the ECS may define fields, the corresponding datatypes and usage, while classifying the fields at core and extended levels.

According to an embodiment, the ECS may be used to maximize interoperability and reuse. In some cases, the concepts represented in ECS may be expanded while considering the intended use cases (i.e., the range or specificity of the intended use cases, e.g., how broad or narrow the intended use cases are). For example, a field that may be defined with narrow, lacking, or incorrect definitions may limit future use. Accordingly, a minimum possible number of fields may be added that may adequately capture an event since adding more fields in the future is easier than changing or removing established fields.

Additionally, a field may not be added due to the presence of a concept. For example, a network protocol specification may include a plurality of features that may be obscure and used infrequently. In some examples, field standardization may be avoided.

An embodiment of the present disclosure includes a field set that may be a namespace. For example, a field set may create an independent schema section for understanding a concept in isolation. In some examples, a complex concept may be captured appropriately based on nesting. In some cases, a field set may include multiple sub-components that may be used to build a large concept (i.e., dns.question.class, dns.question.answer, dns.question.type).

An embodiment of the present disclosure may be configured to consistently perform naming across the schema. In some cases, naming consistency may ensure ease of learning and memorizing field names. In some examples, a term with a broad meaning may not be limited to a single case.

According to an embodiment, an extra field may be introduced when adding or expanding a concept. In some cases, an existing field may be used or reused to reduce (e.g., avoid) duplicating fields. For example, leveraging a consistent field across event sources may generate a straightforward query and a straightforward visualization.

For example, in case of an application or framework that may generate a unique ID for each emitted log. In some examples, an event.id field may be added to an application (e.g., instead of custom.id field that may be specific to the application).

In some cases, reusing fields may simplify capture of multiple entities of a type within a single event. According to an example, the user* field set and the reuse user.target* provides for collecting the same detail about the acting and target users. In some examples, redefining the entire user* field set may be unnecessary. For example, an array of field set reuses may be considered in limited use if multiple of the same reuse are captured.

An embodiment of the present disclosure includes a custom field as a feature. In some cases, a custom field may be used to completely capture event contents. For example, users and integrations may be enabled to add custom fields to capture a concept that may not have been defined in ECS. In some examples, a custom field provides flexibility to a user to add a field for an internal use case, for including less common concepts, and for performing experimentation.

An embodiment of the present disclosure may include a core field that may be common across each use case. In some cases, a core field may refer to a generalized field that may be used by analysis content (e.g., searches, visualizations, dashboards, alerts, machine learning jobs, reports, etc.) across multiple use cases. Accordingly, an analysis content that may be designed to operate on the fields may function accurately on data from a relevant source.

According to an embodiment, an extended field may be populated. In some examples, an extended field may refer to a field other than a core field. For example, an extended field may apply to a narrow use case or may be interpreted based on the use case. In some examples, an extended field may change over time. In some cases, an ECS may not define a custom field which may refer to an additional field that is defined by the user or the integration (i.e., may be defined independently of ECS).

According to an exemplary embodiment of the present disclosure, a document may include a @timestamp field. In some cases, the {ref}/mapping-types.html[data type] that may be defined for an ECS field may be used. In some examples, the ecs.version field may be used to define the version of ECS used and a maximum possible number of fields may be mapped to the ECS.

According to an embodiment, a field name may be lower case. In some examples, words in the field name may be combined using an underscore (i.e., the field name may not include any special character except underscore). In some cases, use of a present tense unless a field may describe historical information. For example, singular and plural names may be properly used to reflect the field content (e.g., requests_per_sec rather than request_per_sec). In some examples, a prefix may be used for each field (i.e., except base field) and fields may be nested inside a field set with dots (e.g., the document structure may be nested JSON objects). In some cases, the nesting of field sets may be organized from general to specific, to provide for grouping fields into objects with a prefix like host*. In some cases, repetition or stuttering of words may be avoided (e.g., in case part of the field name is already in the name of the field set). Additionally, the field names may not include abbreviations (in some cases, an exception may be made when the name for the concept may be strongly in favor or the abbreviation, e.g. ip fields or field sets such as os, gen).

According to an embodiment, a user and an integration may capture additional information in an event as a custom field. In some cases, a custom field may be used by design while ensuring that no user may be blocked due to not being supported by ECS. In some cases, a custom field in ECS may be modeled to reduce chances of conflict with a future version of ECS.

According to an embodiment, a field set attribute may include a name, a title, a description, and fields. For example, the name of the field set may be lowercase and with underscores to separate words for programmatic use. For example, the title of the field set may include a capitalized name of the field set with spaces to separate words for use in documentation section titles. Additionally, the description of the field set may include two subsequent newlines that may create a new paragraph. For example, the fields of the field set attribute may refer to a YAML array.

In some examples, a field set may refer to a group of fields that may be defined at the root of the events. For example, the fields of the event field set may be nested such as {“event”:{“id”:“too” }}. In some examples, a field set reuse may enable defining of a group of fields that may be expected to be used in multiple places, such as geo, which may appear under source, destination, etc.

According to an embodiment, an ECS may model information using the name of concepts, and may prevent proper names such as tool names, project names, or company names. By using extension, embodiments of the present disclosure are able to nest custom fields under a proper name while ensuring safety of adding custom fields.

According to an exemplary embodiment of the present disclosure, an IronNet C2 threat intel feed may proactively block adversaries before the adversaries attack the organization. For example, the purpose built threat intelligence feed may enable to proactively block known, new, and unreported command and control (C2) infrastructure. By using the IronNet C2 threat intel feed, embodiments of the present disclosure may enable SOC to shift left and actively block known C2 and emerging C2 threat indicators of compromise (IoCs). Additionally, use of IronNet C2 threat intel feed may provide for security teams to become intelligence-led based on exposing the adversaries and evolving tradecraft targeting organization infrastructure. Moreover, the IronNet C2 threat intel feed may accelerate breach time detection and threat response by prioritizing the threats that have maximum importance.

Accordingly, a method, apparatus, non-transitory computer readable medium, and system for active command and control server detection via distributed network scanning are described. One or more aspects of the method, apparatus, non-transitory computer readable medium, and system include identifying a plurality of leads from amongst the computing devices by comparing data received from the computing devices to soft fingerprints; probing each of the plurality of leads using an emulator, and generating a threat indicator in response to the probing; enriching the plurality of leads in response to probing each of the plurality of leads and appending enrichment data to the threat indicator; and transmitting the threat indicator and the enrichment data to update a search cluster.

In some aspects, the leads comprise address and port combinations for possible command and control servers for malware, wherein each of the possible command and control servers comprises a type of command and control server, and wherein the emulator emulates an agent for the type of command and control server for each lead.

Some examples of the method, apparatus, non-transitory computer readable medium, and system further include identifying the plurality of leads comprises identifying the plurality of leads based on a configuration of where to gather leads, and what leads to gather defined by a lead generation query.

Some examples of the method, apparatus, non-transitory computer readable medium, and system further include identifying the plurality of leads comprises identifying the plurality of leads using soft fingerprints.

Some examples of the method, apparatus, non-transitory computer readable medium, and system further include probing each of the leads comprises probing each of the leads with an HTTP or HTTPS request.

In some aspects, the enriching comprises enriching based on analyzing an HTTP or HTTPS response.

In some aspects, the enriching comprises enriching based on analyzing a hash of an HTTP or HTTPS response.

In some aspects, the enriching comprises enriching based on analyzing whether a string is contained within an HTTP or HTTPS response.

In some aspects, the enriching comprises enriching based on analyzing whether a regular expression is matched within an HTTP or HTTPS response.

In some aspects, the enriching comprises enriching based on analyzing an TCP Banner.

In some aspects, the enriching comprises enriching based on analyzing a hash of a TCP Banner.

In some aspects, the enriching comprises enriching based on analyzing whether a string is contained within a TCP Banner.

In some aspects, the enriching comprises enriching based on analyzing whether a regular expression is matched within a TCP Banner.

Some examples of the method, apparatus, non-transitory computer readable medium, and system further include employing the search cluster having been updated to block access from a subset of the plurality of leads based on the threat indicator and the enrichment data associated with the subset of the plurality of leads.

Some examples of the method, apparatus, non-transitory computer readable medium, and system further include pulling intelligence indicators from the search cluster for the subset of the plurality of leads based on the threat indicator and the enrichment data associated with the subset of the plurality of leads. Some examples further include writing the intelligence indicators to files stored on a storage appliance, wherein these files are used to block access from the subset of the plurality of leads.

Some examples of the method, apparatus, non-transitory computer readable medium, and system further include probing each of the plurality of leads comprises probing each of the plurality of leads from at least two distinct regions representing at least two countries.

Some examples of the method, apparatus, non-transitory computer readable medium, and system further include probing each of the plurality of leads comprises probing each of the plurality of leads using at least two types of user agents.

Some examples of the method, apparatus, non-transitory computer readable medium, and system further include probing each of the plurality of leads comprises probing each of the plurality of leads to retrieve a respective configuration file; and the enriching comprises enriching each of the plurality of leads by tracking changes to the configuration file over time.

Some of the functional units described in this specification have been labeled as modules, or components, to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method in a network of computing devices comprising:
identifying a plurality of leads from amongst the computing devices by comparing data received from the computing devices to soft fingerprints;
probing each of the plurality of leads using an emulator, and generating a threat indicator in response to the probing;
enriching the plurality of leads in response to probing each of the plurality of leads and appending enrichment data to the threat indicator; and
transmitting the threat indicator and the enrichment data to update a search cluster.

2. The method of claim 1 wherein the leads comprise address and port combinations for possible command and control servers for malware, wherein each of the possible command and control servers comprises a type of command and control server, and wherein the emulator emulates an agent for the type of command and control server for each lead.

3. The method of claim 1 further comprising:
said identifying comprising identifying said plurality of leads based on a configuration of where to gather leads, and what leads to gather defined by a lead generation query.

4. The method of claim 1 further comprising:
said identifying comprising identifying said plurality of leads using soft fingerprints.

5. The method of claim 1 further comprising:
said probing each of said leads comprising probing each of said leads with an HTTP or HTTPS request.

6. The method of claim 1 further comprising:
said enriching comprising enriching based on analyzing an HTTP or HTTPS response.

7. The method of claim 1 further comprising:
said enriching comprising enriching based on analyzing a hash of an HTTP or HTTPS response.

8. The method of claim 1 further comprising:
said enriching comprising enriching based on analyzing whether a string is contained within an HTTP or HTTPS response.

9. The method of claim 1 further comprising:
said enriching comprising enriching based on analyzing whether a regular expression is matched within an HTTP or HTTPS response.

10. The method of claim 1 further comprising:
said enriching comprising enriching based on analyzing a TCP Banner.

11. The method of claim 1 further comprising:
said enriching comprising enriching based on analyzing a hash of a TCP Banner.

12. The method of claim 1 further comprising:
said enriching comprising enriching based on analyzing whether a string is contained within a TCP Banner.

13. The method of claim 1 further comprising:
said enriching comprising enriching based on analyzing whether a regular expression is matched within a TCP Banner.

14. The method of claim 1 further comprising:
employing the search cluster having been updated to block access from a subset of said plurality of leads based on the threat indicator and the enrichment data associated with the subset of said plurality of leads.

15. The method of claim 14 further comprising:
said employing said search cluster comprising:
pulling intelligence indicators from the search cluster for the subset of said plurality of leads based on the threat indicator and the enrichment data associated with the subset of said plurality of leads; and
writing the intelligence indicators to files stored on a storage appliance, wherein these files are used to block access from said subset of said plurality of leads.

16. The method of claim 1 further comprising:
said probing comprising probing each of said plurality of leads from at least two distinct regions representing at least two countries.

17. The method of claim 1 further comprising:
said probing comprising probing each of said plurality of leads using at least two types of user agents.

18. The method of claim 1 further comprising:
said probing comprising probing each of said plurality of leads to retrieve a respective configuration file; and
said enriching comprising enriching each of said plurality of leads by tracking changes to said configuration file over time.

19. A system in a network of computing devices comprising:
a leads pipeline identifying a plurality of leads from amongst the computing devices by comparing data received from the computing devices to soft fingerprints;
a scanner pipeline probing each of the plurality of leads using an emulator, wherein the emulator emulates an agent for the type of command and control server for each lead, and generating a threat indicator in response to the probing;
an enrichment pipeline enriching the plurality of leads in response to probing each of the plurality of leads and appending enrichment data to the threat indicator; and
a shipping pipeline transmitting the threat indicator and the enrichment data to update a search cluster.

20. The system of claim 19 wherein the leads comprise address and port combinations for possible command and control servers for malware, wherein each of the possible command and control servers comprises a type of command and control server.

21. The system of claim 19 further comprising:
said leads pipeline, wherein said identifying comprises identifying said plurality of leads based on a configuration of where to gather leads, and what leads to gather defined by a lead generation query.

22. The system of claim 19 further comprising:
said leads pipeline, wherein said identifying comprises identifying said plurality of leads using soft fingerprints.

23. The system of claim 19 further comprising:
said scanner pipeline, wherein said probing each of said leads comprises probing each of said leads with an HTTP or HTTPS request.

24. The system of claim 19 further comprising:
said enrichment pipeline, wherein said enriching comprises enriching based on analyzing an HTTP or HTTPS response.

25. The system of claim 19 further comprising:
said enrichment pipeline, wherein said enriching comprises enriching based on analyzing a hash of an HTTP or HTTPS response.

26. The system of claim 19 further comprising:
said enrichment pipeline, wherein said enriching comprises enriching based on analyzing whether a string is contained within an HTTP or HTTPS response.

27. The system of claim 19 further comprising:
said enrichment pipeline, wherein said enriching comprises enriching based on analyzing whether a regular expression is matched within an HTTP or HTTPS response.

28. The system of claim 19 further comprising:
said enrichment pipeline, wherein said enriching comprises enriching based on analyzing a TCP Banner.

29. The system of claim 19 further comprising:
said enrichment pipeline, wherein said enriching comprises enriching based on analyzing a hash of a TCP Banner.

30. The system of claim 19 further comprising:
said enrichment pipeline, wherein said enriching comprises enriching based on analyzing whether a string is contained within a TCP Banner.

31. The system of claim 19 further comprising:
said enrichment pipeline, wherein said enriching comprises enriching based on analyzing whether a regular expression is matched within a TCP Banner.

32. The system of claim 19 further comprising:
said network of computing devices, wherein a plurality of said computing devices employ the search cluster having been updated to block access from a subset of said plurality of leads based on the threat indicator and the enrichment data associated with the subset of said plurality of leads.

33. The system of claim 32 further comprising:
said network of computing devices, wherein plurality of computing devices employ said search cluster having been updated further comprising:
pulling intelligence indicators from the search cluster for the subset of said plurality of leads based on the threat indicator and the enrichment data associated with the subset of said plurality of leads; and
writing the intelligence indicators to files stored on a storage appliance, wherein these files are used to block access from said subset of said plurality of leads.

34. The system of claim 19 further comprising:
said scanner pipeline, wherein said probing comprises probing each of said plurality of leads from at least two distinct regions representing at least two countries.

35. The system of claim 19 further comprising:
said scanner pipeline, wherein said probing comprises probing each of said plurality of leads using at least two types of user agents.

36. The system of claim 19 further comprising:
said scanner pipeline, wherein said probing comprises probing each of said plurality of leads to retrieve a respective configuration file; and
said enrichment pipeline, wherein said enriching comprises enriching each of said plurality of leads by tracking changes to said configuration file over time.
